(19) United States
(12) Patent Application Publication
(10) Pub. No.: US 2005/0152519 A1
(43) Pub. Date: Jul. 14, 2005

(54) Music navigator for digital audio playback

(76) Inventors: Scott A. Rush, Livonia, MI (US); Andrew W. Gellatly, Macomb, MI (US); James M. Kortge, Ferndale, MI (US)

Correspondence Address: CHRISTOPHER DEVRIES;General Motors Corporation, Mail Code 482-C23-B21, P.O. Box 300, Detroit, MI, 48265-3000, US

(21) Appl. No.: 10/756,664

(22) Filed: Jan. 13, 2004

(51) Int. Cl. H04M 11/00

(52) U.S. Cl. 379/101.01

(57) ABSTRACT

Methods and apparatus are provided for organizing pre-recorded digital compressed audio files for convenient playback on a device installed in a moving vehicle. The apparatus comprises a scanning function that orders the files into categories, such as “Artist” and “Album”, which are each linked to an index of their associated tracks. The indexing scheme provides a user, such as the driver of an automobile, an intuitive method of finding a desired track with minimal distraction.

### TECHNICAL FIELD

The present invention generally relates to audio systems, and more particularly relates to the ordering of digital compressed audio files.

### BACKGROUND

With the advent of digital compression techniques for audio files, using formats such as MP3, WMA, etc., it becomes possible to place hundreds or even thousands of compressed audio files on a convenient storage media, such as a CDROM, DVDROM, or hard disc drive. For example, the storage capacity of a conventional CD is approximately 70 minutes of music, whereas a CD with MP3 files written on it could hold over 1,000 minutes of music. This greatly expanded storage capability can offer a user a vast store of entertainment and educational material, with much of it readily available on the Internet.

With such a large number of randomly ordered files to choose from, however, it can be tedious and time-consuming for the user to navigate through all of the files to find a desired file. For home-type computer systems with high capacity hard drives and appropriate software, a large database of compressed audio files is typically ordered by Artist and Album to make the selection process relatively convenient. This type of conventional ordering system has generally not been adapted for entertainment systems installed in automobiles, however, due to system capacity limitations and cost considerations. Therefore, an indexing and selection system for compressed audio files that would be compatible with the constraints of an automobile playback system could significantly increase the entertainment/educational opportunities available for the driver and passengers. Moreover, if the indexing and selection process were both convenient and intuitive for the driver, the operational distractions could be minimized.

Accordingly, it is desirable to provide a convenient and intuitive ordering system for digital compressed audio files to be used in an automobile entertainment system. In addition, it is desirable to provide a low-cost ordering system suitable for large volume automobile production. Furthermore, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, devices and methods are provided for organizing pre-recorded digital compressed audio files for convenient playback on a device installed in a moving vehicle, such as an automobile. One method includes the steps of loading a random sequence of digital compressed audio files into the device and sorting the random sequence of digital compressed audio files by specific category. In addition, one method includes indexing the sorted category files with key field designations and storing the indexed key field designations, so that a user, such as an automobile driver, can select a digital compressed audio file by scrolling a specific key field designation.

An exemplary device for playing back a desired track on a pre-recorded media comprises a media reader for entering the pre-recorded media data into the device, a processor for scanning the entered data and creating a database containing an ordered list of tracks by Artist and Album category, and a user interface that includes a display and a set of control switches, such that a user can select a category and then scroll through the ordered list of tracks within that category to find the desired track.

### BRIEF DESCRIPTION OF THE DRAWINGS

The present invention will hereinafter be described in conjunction with the following drawing figures, wherein like numerals denote like elements, and

FIG. 1 is a block diagram illustrating an exemplary front panel display of a playback device for digital compressed audio files;

FIG. 2 is a block diagram illustrating an exemplary front panel display of a playback device for digital compressed audio files during the scan mode;

FIG. 3 is a block diagram illustrating an exemplary front panel display of a playback device for digital compressed audio files at the completion of the scan mode;

FIG. 4 is an illustration of an exemplary indexing arrangement for digital compressed audio files; and

FIG. 5 is a flow diagram for an exemplary playback process of digital compressed audio files.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention pertain to the area of automotive playback systems for digital compressed audio files, such as MP3. Digital compression techniques enable the storage of large numbers of audio files (tracks) on portable media, such as CD or DVD, which can be played back on a compatible (e.g., MP3) entertainment system installed in an automobile. With many different tracks (perhaps hundreds) to choose from, it can become time-consuming and distracting for a driver to find and select a particular desired track for playback. Therefore, an exemplary embodiment of an indexing system for ordering digital compressed audio files in an automotive playback system is disclosed herein, which provides a convenient and intuitive selection process for the driver.

According to an exemplary embodiment suitably for use in an automobile entertainment system, a scanning function, which may be designated as a “Music Navigator”, is incorporated into a playback system in order to generate an indexed database. In this embodiment, the exemplary scanning function/Music Navigator provides an indexing capability that orders the stored tracks of compressed audio for convenient selection by the user, who is typically the driver of the vehicle.

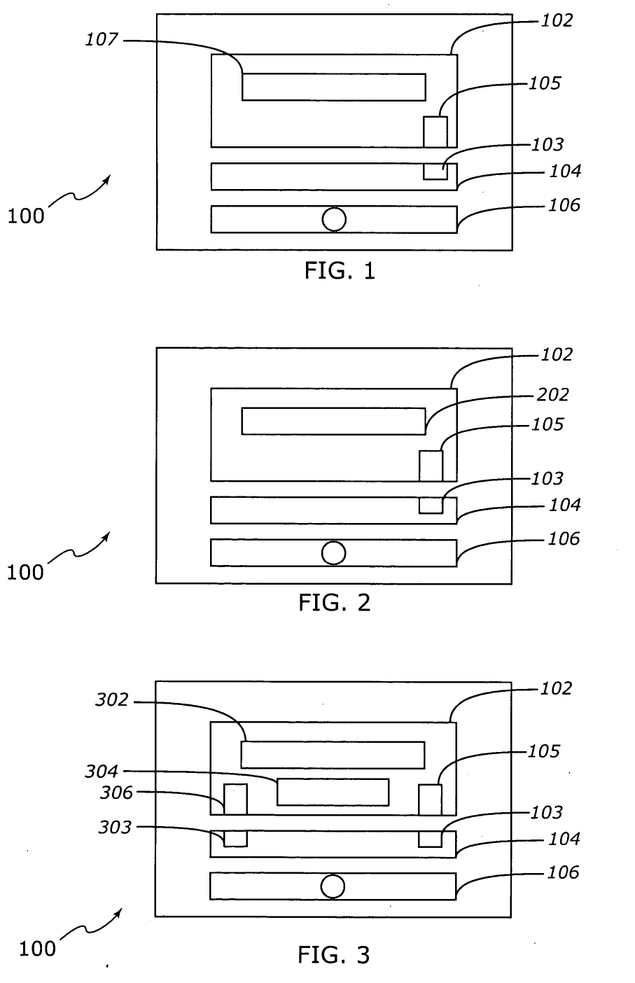

An exemplary embodiment of an entertainment system front panel 100 is shown in FIG. 1. A display screen 102 provides the user with selection information, such as disc number, song title, play mode, and so forth. Display screen 102 also identifies the functions of individual push buttons on soft key assembly 104. In this exemplary embodiment, the icon 105 on display screen 102 identifies its corresponding push button 103 as the scanning function activate command, which the user can press to start the ordering process of the scanning function.

In a typical situation, a user (e.g., a driver) would load a pre-recorded media (CD, DVD) into the entertainment system, and the system would display a first track for playback in box 107 on display screen 102, as indicated in FIG. 1. In this example, the song title of the first track is shown, but with no identification of Artist or Album. The user can then operate the system conventionally, using the push buttons and/or control knob on control assembly 106 (next/previous, etc.) to find other tracks in whatever sequence they had been written to the media. Alternately, the user could choose to take advantage of the exemplary scanning function for a convenient ordering of the written tracks. When the user activates the exemplary scanning function (push button 103), display screen 102 can be configured to show the scan function in process, as indicated by the example of box 202 in FIG. 2. In one embodiment, a previously selected track would continue its playback in the foreground while the scanning function progressed in the background.

When the exemplary scanning function is completed, display screen 102 will typically display a first ordered track song title 302, and also the corresponding Artist name or Album title (whichever is selected) in box 304, as shown in FIG. 3. In this embodiment, the user can choose whether the selection category should be Artist or Album by toggling the push button 303, corresponding to the Artist/Album icon 306. In this embodiment, both Artist and Album categories are organized in alphabetical order, and each Artist or Album will be linked to its respective tracks. The user can then quickly search for the Artist/Album of choice and play their respective linked tracks by using the playback controls 106 on front panel 100.

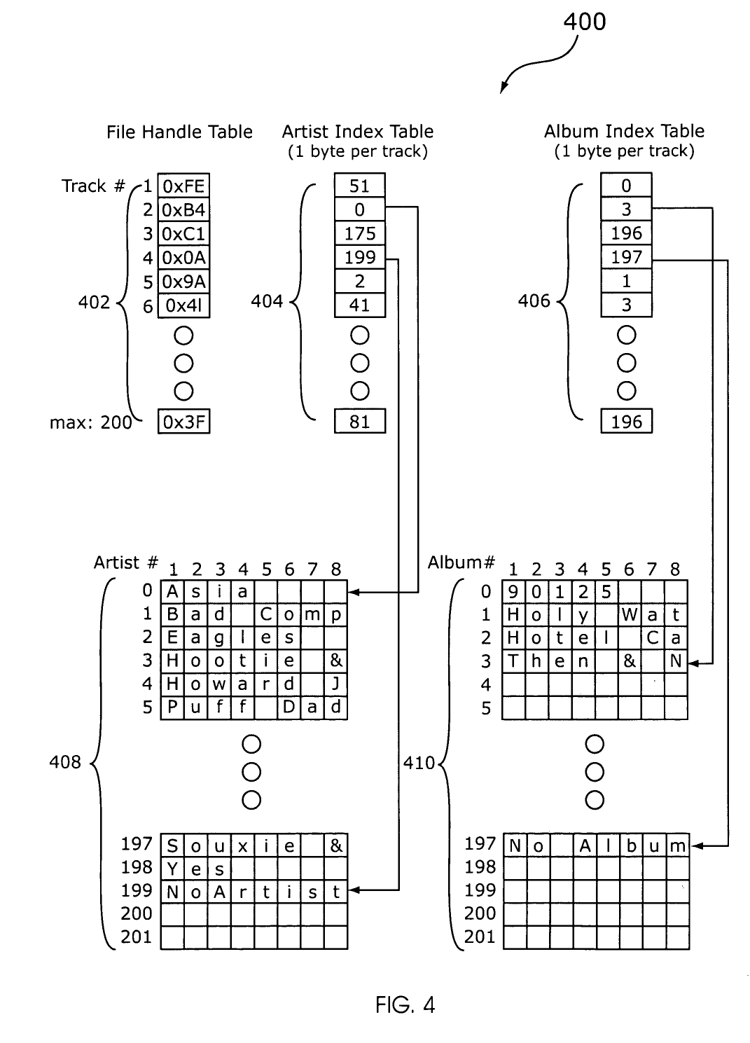

An exemplary embodiment of an indexing arrangement 400 is illustrated in FIG. 4. A File Handle Table 402 represents an example list of handle identifiers, each of which uniquely corresponds to a particular compressed audio track on a pre-recorded media. These identifiers are typically one byte per track, although various implementations may use fewer or more bits in their representation. When the exemplary scanning function is activated, as described above, the handle identifier data is retrieved along with song title, Artist, and Album information. The identifiers are then sorted in such a manner so that Artist and Album information can be rapidly retrieved for each track (song) on a pre-recorded media.

An exemplary sorting arrangement of Artist and Album categories is illustrated by the data structure shown in FIG. 4. In this embodiment, the Artist category is organized as an Artist listing 408, and the Album category is organized as an Album listing 410. The individual tracks associated with each Artist are organized as an Artist Index Table 404, and the individual tracks associated with each Album are organized as an Album Index Table 406. In this exemplary embodiment, Artist Index Table 404 and Album Index Table 406 each have one byte entry for every song file encountered on the installed media, and are filled during the exemplary scanning function process, after the Artist listing 408 and the Album listing 410 have been completed.

In the exemplary Artist listing 408 and Album listing 410, as shown in FIG. 4, only eight characters are used as “key fields” for the individual Artist or Album selection within each category, in order to conserve memory utilization. Where the Artist name or Album title is longer than eight characters, the Artist name and Album title are truncated to fit within the eight character key fields. For example, Artist # 0 is “Asia”, Artist # 1 is “Bad Company”, and so on. In similar fashion, Album # 0 is “90125”, Album # 1 is “Holy Water”, etc. In alternate embodiments, the key fields may be any arbitrary number of characters, as limited by the implementation-specific memory constraints. Still further embodiments may have sufficient memory to store the entire database, and therefore may not require or implement memory conservation in any manner.

In this embodiment, the maximum number of active file spaces in each category is set at 200, plus a “No Artist” and a “No Album” space, as shown in lines 201 of Artist listing 408 and Album listing 410. For illustrative purposes in this example, the number of active Artist files is 198, and the number of active Album files is 196. The maximum number of available file spaces in this embodiment is limited to 200 in order to conserve device memory, while other embodiments of this indexing arrangement may have fewer or greater maximum number of audio files.

For the embodiment shown in FIG. 4, the maximum number of bytes per disc required for storage of the audio files in a device memory can be calculated as follows:
(Maximum tracks)×(1 File Handle+1 Artist Index+1 Album Index+Artist List Bytes+Album List Bytes)=(200)×(1+1+1+8+8)=(200)×(19)=3,800.
Therefore, the exemplary embodiment of FIG. 4 only utilizes 3,800 bytes of memory per disc, which is generally compatible with the capacity of an automotive entertainment system.

In the exemplary embodiment of FIG. 4, the Artist names and Album titles are listed in alphabetical order, as shown in Artist listing 408 and Album listing 410. This alphabetical listing is disclosed as one embodiment, since it is considered to be convenient and intuitive for a typical user. Alternate embodiments of the disclosed indexing scheme may use other listing arrangements, if deemed advantageous for a particular application.

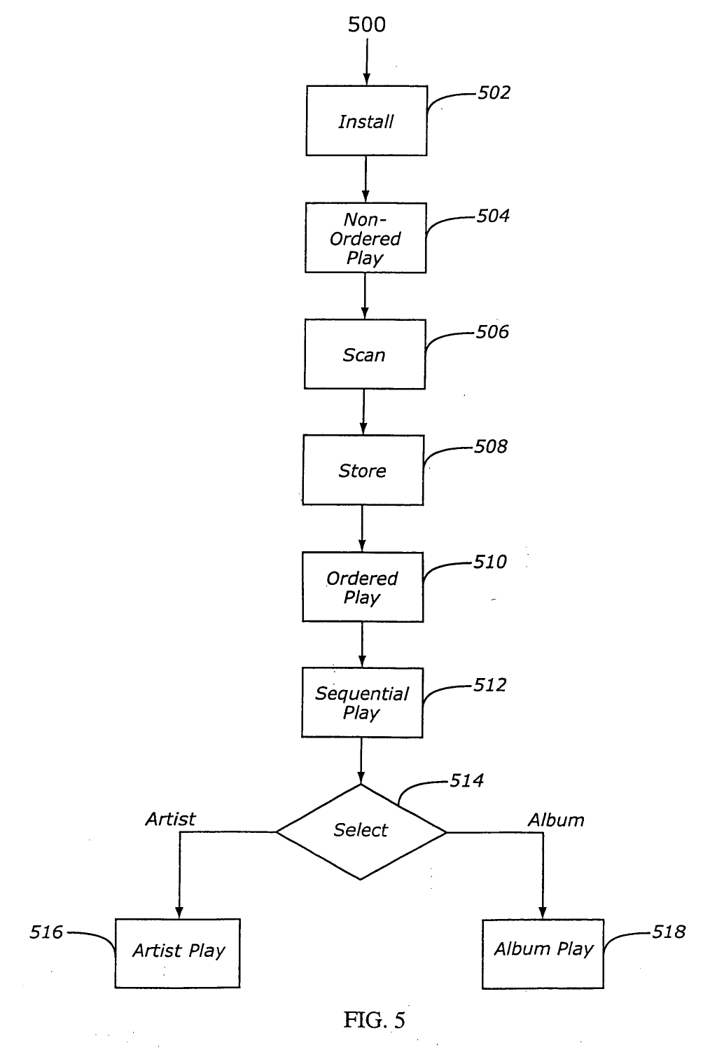

A typical operational sequence 500 for an exemplary embodiment of an automotive entertainment system as disclosed herein is depicted in the flow diagram shown in FIG. 5. Initially, a media containing pre-recorded digital compressed audio files, such as a CD or DVD with written MP3 files, is installed into the exemplary entertainment system in any suitable manner (step 502). In a typical embodiment, the media would be automatically scanned in a conventional manner, and the first available track would be played, in accordance with the pre-recorded sequence of the media (step 504). Concurrently, the entertainment system display screen would show the song title, but not the Artist or the Album, in box 107 of FIG. 1.

The user can then choose to let the system play back tracks in their original pre-recorded order, which may be completely random, or the user can activate the exemplary scanning function (step 506) by any suitable action, as exemplified by pressing the button 103 associated with the scan icon 105 (FIG. 1). Once activated, the exemplary scanning function proceeds to create an indexed database, such as the one designated 400 in FIG. 4, which is then stored within the exemplary entertainment system (step 508). During this process, the system display screen 102 can monitor the scanning function progress, as shown in box 202 of FIG. 2.

When the exemplary scanning process (steps 506 and 508) is completed, the default selection in this embodiment is shown on display screen 102 as “Artist”, indicated by designation 306 in FIG. 3. In addition, the first Artist name is displayed in box 304, and the song title associated with the first track linked to that Artist is displayed in box 302. As shown in FIG. 4, a track (0) in Artist Index Table 404 is linked to its associated Artist # 0 in Artist listing 408. In the FIG. 4 example, the first Artist in alphabetical order is “Asia”, corresponding to the (0) link. In an exemplary embodiment, the first song track associated with the Artist Asia would commence playing (step 510) in approximately 1.5 seconds. Thereafter, unless otherwise directed by the user, the remaining tracks associated with the Artist Asia would play sequentially, for example, in alphabetical order (step 512).

At step 514, the user can select either the Artist or Album category with push button 303, as noted above, and the selected category will be displayed in box 306, as shown in FIG. 3. The user can then find any indexed song track associated with the selected category by using conventional playback controls (106), such as “next/previous”, “repeat”, “random”, and so forth (step 516 for Artist, step 518 for Album). This approach can minimize user distraction by ordering the media files in a way that is intuitive, i.e., alphabetically by Artist or Album, rather than by the somewhat random or circumstantial pre-recorded ordering of the media audio files.

In an alternate embodiment, the conventional automatic scan of step 504 could be replaced by an automatic exemplary scanning function without user intervention, which would eliminate step 504 and preclude user action in step 506.

Accordingly, the shortcomings of the prior art have been overcome by providing an improved indexing system for convenient user playback of pre-recorded digital compressed audio files for an automotive entertainment system. The exemplary scanning function described herein provides a method for retrieving and organizing audio files based on Artist and Album categories, in conjunction with associated songs/tracks. This information is now generally embedded in digital compressed audio files via such techniques as ID3 tags in MP3 files. The exemplary scanning function creates a database that enables a user, such as the driver of a vehicle, to quickly and intuitively find a desired file with minimal effort and distraction. Moreover, the use of relatively short key fields as identifiers for the Artist and Album listings helps to conserve device memory. As such, the exemplary embodiment offers a relatively low-cost approach for high volume applications, such as automobile entertainment systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method of selecting a digital compressed audio file for playback in a device installed in a moving vehicle, comprising the steps of:
receiving a sequence of digital compressed audio files at the device;
sorting the random sequence of digital compressed audio files by specific category;
indexing the sorted category files with key field designations; and
storing the indexed key field designations, wherein a user can select a digital compressed audio file by scrolling a specific key field designation.

2. The method of claim 1 wherein a specific category is Artist.

3. The method of claim 1 wherein a specific category is Album.

4. The method of claim 2 wherein a key field designation represents a particular Artist.

5. The method of claim 3 wherein a key field designation represents a particular Album.

6. The method of claim 4 wherein the step of indexing links each Artist with associated digital compressed audio files.

7. The method of claim 5 wherein the step of indexing links each Album with associated digital compressed audio files.

8. A device installed in a moving vehicle for playing back selected digital compressed audio files, comprising:
a user interface configured to receive pre-recorded digital compressed audio files in a random sequence;
a scanning apparatus configured to sort the randomly sequenced digital compressed audio files into specific categories, with each sorted specific category indexed with key field designations;
a memory configured to store the sorted digital compressed audio files;
a visual display associated with the user interface, the visual display configured to display a selected category and to also display a digital compressed audio file within that category by indexed key field designation; and
selector switches associated with the user interface, wherein a user can operate the selector switches to activate the scanning apparatus, select a specific category, and select a digital compressed audio file within the selected category by scrolling the displayed indexed key field designations.

9. The device of claim 8 wherein the moving vehicle is an automobile.

10. The device of claim 8 wherein the random sequence of digital compressed audio files is in MP3 format.

11. The device of claim 8 wherein the random sequence of digital compressed audio files is in WMA format.

12. The device of claim 8 wherein a specific category is Artist.

13. The device of claim 8 wherein a specific category is Album.

14. The device of claim 8 wherein a key field designation represents a particular Artist.

15. The device of claim 8 wherein a key field designation represents a particular Album.

16. The device of claim 14 wherein each Artist is indexed to associated digital compressed audio files.

17. The method of claim 15 wherein each Album is indexed to associated digital compressed audio files.

18. A method of playing a desired track on a media installed in a moving vehicle, comprising the steps of:
creating an ordered list of tracks on the media;
scrolling through the ordered list to find the desired track; and
playing the desired track.

19. The method of claim 18 wherein the ordered list comprises Artist and Album categories.

20. The method of claim 19 wherein the Artist and Album categories are each indexed to associated tracks.

21. The method of claim 18 wherein the scrolling step comprises processing a user input to identify a scrolling direction.

22. The method of claim 21 wherein an indexed category is scrolled to select a desired track.

23. A playback device installed in a moving vehicle for playing a desired track on a media, the playback device comprising:
a media reader configured to receive the media;
a processor configured to create an ordered list of tracks on the media, to receive a user selection of a scrolling direction, to scroll through the ordered list of tracks to find the desired track; and
a database configured to store the ordered list.

24. The playback device of claim 23 wherein the moving vehicle is an automobile.

25. The playback device of claim 23 wherein the tracks on the media are digital compressed audio files.
